(19) United States
(12) Patent Application Publication
(10) Pub. No.: US 2008/0150492 A1
(43) Pub. Date: Jun. 26, 2008

(54) Portable device with supercapacitor

(75) Inventors: Jere Anttila, Turku (FI); Markus Aaltonen, Piikkio (FI)

Correspondence Address: HARRINGTON & SMITH, PC, 4 RESEARCH DRIVE, SHELTON, CT, 06484-6212, US

(73) Assignee: Nokia Corporation

(21) Appl. No.: 11/999,073

(22) Filed: Dec. 3, 2007

(30) Foreign Application Priority Data
Dec. 22, 2006 (GB) 0625537.6

(51) Int. Cl. H02J 7/00

(52) U.S. Cl. 320/166

(57) ABSTRACT

A portable device includes a device engine operable to control functions of the portable device when the mobile communications device is on, a real-time clock operable to run when the portable device is on and when it is off, and terminals for connection to a removable battery, the terminals being operable to couple the device engine and the real-time clock to a battery for powering the device engine and the real-time clock. The device also includes a supercapacitor connected in parallel to the terminals. The supercapacitor is operable to store energy whilst a battery is connected to provide energy to the portable device. Whilst no battery is connected and operable to provide energy to the portable device, the supercapacitor is operable to power the device engine when the portable device is on and is also operable to power the real-time clock.

### FIELD OF THE INVENTION

The present invention related to a portable device comprising a device engine, a real-time clock, a supercapacitor and terminals for connection to a battery.

### BACKGROUND TO THE INVENTION

Portable devices, such as mobile communications devices, are typically powered by a removable rechargeable battery. The operating time of the battery is usually of the order of a few days, so the user is required frequently to charge the battery. However, this is not always convenient.

It is relatively common for users to carry a spare battery, for substitution when the battery connected to the mobile communications device has discharged. Conventionally, the device should be turned off before the battery is removed. Thus, the user should power down (switch off) the device, and then wait for the device to turn on (start up) after the replacement battery has been connected.

It is known to use a small, bridge battery to allow the phone to remain powered when the main battery is removed and replaced, a procedure known as hot-swapping.

US 2004/0021446 describes a supercapacitor connected in parallel to a main battery of a portable communications device. The supercapacitor can be used to provide power to a microprocessor, radio, and peripherals of the portable electronics device. This circumvents the need for a bridge battery, therefore avoiding the use of any corresponding complicated logic circuitry.

Computers and mobile communications devices sometimes are provided with a real-time clock. The real-time clock keeps track of the current time when the computer or mobile communications device is turned off. To achieve this, real-time clocks are run on a separate battery that is not connected to the normal power supply, so that they are powered even when the normal power supply is disconnected. This has implications for safe disposal of the device at the end of its life.

U.S. Pat. No. 5,905,365 relates to a power supply for a real-time clock in a computer. The power supply includes two capacitors and a battery, which is a lithium cell. When the computer is turned off, the power stored in the capacitors is provided to the real-time clock. This results in the time of power consumption from the battery being decreased, thus increasing the lifetime of the battery. However, the additional capacitors can increase the complexity and cost of manufacture of the device.

### SUMMARY OF THE INVENTION

The present invention seeks to ameliorate the above-mentioned problems.

According to a first aspect of the present invention there is provided a portable device comprising: a device engine operable to control functions of the portable device when the mobile communications device is on; a real-time clock operable to run when the portable device is on and when it is off; terminals for connection to a removable battery, the terminals being operable to couple the device engine and the real-time clock to a battery for powering the device engine and the real-time clock; a supercapacitor connected in parallel to the terminals, the supercapacitor being operable to: store energy whilst a battery is connected to provide energy to the portable device; and whilst no battery is connected and operable to provide energy to the portable device: power the device engine when the portable device is on; and power the real-time clock.

The present invention can provide a portable device that remains powered when a battery is swapped. The present invention can also provide a simplified power management solution for the real-time clock, thus reducing the complexity of the manufacturing process and the resulting device.

### BRIEF DESCRIPTION OF THE DRAWINGS

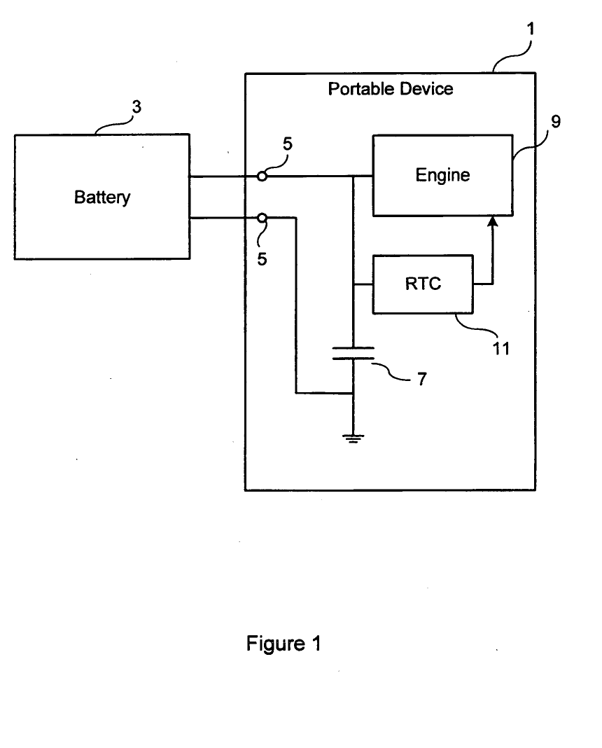

Embodiments of the present invention will now be described, by way of example only, with reference to FIG. 1 which illustrates a portable device according to the present invention.

### DETAILED DESCRIPTION OF AN EMBODIMENT OF THE INVENTION

A typical prior art portable device, such as a mobile communications device, comprises a device engine, a real time clock, and terminals for connection to a removable battery. The device engine controls the functions of the device, and is connected to the battery. Digital systems typically cause some voltage drops and ripple voltage in the voltage that is supplied from the battery. To counteract this, a capacitor is usually connected to the device engine to smooth the voltage. The real time clock (RTC) is provided with a separate power source, so that it can operate when the battery is disconnected or is not able to provide energy. The separate power source can be a small battery or a capacitor connected in parallel to the battery.

Referring now to FIG. 1, a portable device 1 according to the present invention comprises a connection to a battery 3 via terminals 5. A supercapacitor 7 is connected parallel to the terminals 5. A device engine 9 is connected to the terminals 5, so that it can be powered by the battery 3 connected to the terminals 5. An RTC 11 is also connected to the terminals 5, so that it can be powered by the battery 3 connected to the terminals 5. The RTC 11 has an output that is connected to an input of the device engine 9.

The battery 3 is a conventional rechargeable and has a lifetime of a few days, where the lifetime of the battery 3 depends on frequency and the extent of usage of the portable device 1.

The supercapacitor 7 can also be any supercapacitor 7 that is known in the art. The supercapacitor 7 differs from a normal electrostatic or electrolytic capacitor by having a much higher energy density. For example, supercapacitors that are currently available have an energy density of around 5 Wh/kg compared to an energy density in a normal capacitor of 0.05 Wh/kg. The capacitance of a supercapacitor can be as much as 100 mF to 10 F, whereas the capacitance of a normal capacitor of corresponding volume is around 1 mF. The minimum capacitance of the supercapacitor 7 may be 10 mF.

The engine 9 is operable to control functions of the portable device 1. These functions can include controlling a user interface, storing data in a memory, controlling a camera to take photographs, and sending and receiving data. The engine 9 also includes circuitry for performing functions of the device. For example, the engine 9 may comprise a transmitter, a receiver, a keypad, a screen, a modem, and a camera.

The portable device 1 can be turned on and off by a user using its user interface. When the portable device 1 is on, the engine 9 is powered and controls functions of the device 1. When the portable device 1 is off, the engine 9 is not powered.

The RTC 11 is run when the portable device 1 is on and when it is off. The RTC 11 provides real time information to the engine 9. The real time information can be a count, which the engine 9 can use to calculate the current time. Alternatively, the real time information can be the current time.

When the battery 3 is connected to the terminals 5 and is able to provide energy to the device 1, it charges the supercapacitor 7. The supercapacitor 7 does not require a full-charge detection circuit, and when it is full it simply stops accepting charge. When the battery 3 is removed, for example to swap the battery 3 with a spare battery, or because the portable device 1 has been dropped and the battery has dislocated, the change in voltage at the terminals 5 causes the supercapacitor 7 to discharge. In this way, the supercapacitor 7 can power the engine 9 and the RTC 11.

The capacitance of the supercapacitor 7 is given by C=Q/V. The capacitance that can be usefully used for powering the engine 9 or RTC 11 is given by:

$$C = \frac{𝒬}{{V}_{f} - {V}_{s}} \qquad ( 1 )$$

In equation (1), Q is the charge stored on the supercapacitor 7 when it is fully charged, Vₛ is the minimum operating voltage of the portable device 1, V_{f} is the voltage of the supercapacitor 7 when it is fully charged, and C is the capacitance of the supercapacitor 7. In this example, the capacitance of the supercapacitor is 0.5 F.

Using Q=It, where t is the operating time I is the current consumption of the portable device 1, equation (1) can be rearranged to give the operating time of the portable device 1 when it is powered by only the supercapacitor 7:

$$t = \frac{C ( {V}_{f} - {V}_{s} )}{I} \qquad ( 2 )$$

If the battery 3 is removed when the portable device 1 is turned off, only the RTC 11 is running. In one example, the supply current for the RTC 11 is 1□A, and the minimum and maximum operating voltages are 1.4V and 3.1V respectively. This gives a total operating time of 236 hours. In other examples, the operating time can vary depending on the current consumption and the minimum and maximum operating voltages of the RTC 11.

If the capacitance of the supercapacitor 7 is 10 mF, the total operating time of the RTC 11 when it is powered only by the supercapacitor 7 is 5 hours.

If the battery 3 is removed whilst both the RTC 11 and the device engine 9 are powered the operating time is reduced. The current consumption of the device engine 9 when it is in a sleep state depends on device structure, and may be around 10 mA. The minimum and maximum operating voltages are 4.2V and 3.1V respectively. When the capacitance of the supercapacitor 7 is 0.5 F, this gives a total operating time of 55 seconds when the portable device is powered only by the supercapacitor 7. This operating time is sufficient to allow a user to replace the battery 3 connected to the terminals 5 without requiring the device engine 9 to be powered down. Thus, the supercapacitor 7 allows hot-swapping of the battery 3. This is achieved without the use of a bridge battery.

If the capacitance of the supercapacitor 7 is 10 mF, the total operating time of the portable device may be of the order of 1 second. In another example, the current consumption of the device engine 9 is less that 10 mA, and the operating time of the portable device may be longer.

The supercapacitor 7 can also be used to ensure that a constant voltage is provided to the device engine 9 when a battery 3 is connected. For example, in cold conditions, the impedance of the battery 3 increases significantly. The battery 3 is still able to supply current, but doing so reduces the operating time of the battery 3. However, the supercapacitor 7 is able to provide supplementary current to the device engine 9. The supercapacitor 7 thus provides some compensation for the high internal impedance of the battery 3 by powering the device engine and the real time clock. This improves the performance of the device, as current spikes and ripple voltage can be reduced.

The ability of the supercapacitor 7 to deliver current to the engine 9 and the RTC 11 can allow the use of batteries that provides higher energy density in place of higher current. Thus, batteries with a longer operating time for a given volume can be used without any effect on operation of the device.

The supercapacitor 7 smoothes ripples in a supply voltage line which connects the device engine to the battery 3. Therefore, the complexity of the device, and its manufacturing process, can be reduced. The supercapacitor 7 can also be used when high current spikes are needed by the engine 9, for example when taking photos with a flash light. Because of the presence of the supercapacitor 7, it is not required to draw high current spikes from the battery, so the battery operating time may be increased.

Although the invention has been described with respect to the above embodiments, it should be apparent to those skilled in the art that modifications can be made without departing from the spirit and scope of the invention.

What is claimed is:

1. A portable device comprising:
a device engine operable to control functions of the portable device when the mobile communications device is on;
a real-time clock operable to run when the portable device is on and when it is off;
terminals for connection to a removable battery, the terminals being operable to couple the device engine and the real-time clock to a battery for powering the device engine and the real-time clock;
a supercapacitor connected in parallel to the terminals, the supercapacitor being operable to:
store energy whilst a battery is connected to provide energy to the portable device; and
whilst no battery is connected and operable to provide energy to the portable device:
power the device engine when the portable device is on; and
power the real-time clock.

2. A device as claimed in claim 1, wherein the device is arranged so that the supercapacitor and the battery are able to power the device engine during high power functions

3. A device as claimed in claim 1, wherein the device is arranged so that the supercapacitor is operable to reduce a ripple voltage in a supply voltage line, which connects the device engine to the battery.

4. A device as claimed in claim 2, wherein the device is arranged so that the supercapacitor is operable to reduce a ripple voltage in a supply voltage line, which connects the device engine to the battery.

5. A device as claimed in claim 1, wherein the device is arranged so that the supercapacitor is operable to provide supplementary current to the device engine in cold operating conditions.

6. A device as claimed in claim 2, wherein the device is arranged so that the supercapacitor is operable to provide supplementary current to the device engine in cold operating conditions.

7. A device as claimed in claim 3, wherein the device is arranged so that the supercapacitor is operable to provide supplementary current to the device engine in cold operating conditions.

8. A device as claimed in claim 4, wherein the device is arranged so that the supercapacitor is operable to provide supplementary current to the device engine in cold operating conditions.

9. A portable device comprising:
device engine means operable to control functions of the portable device when the mobile communications device is on;
real-time clock means operable to run when the portable device is on and when it is off;
terminal means for connection to a removable battery, the terminal means being operable to couple the device engine means and the real-time clock means to a battery for powering the device engine means and the real-time clock means;
supercapacitor means connected in parallel to the terminals, the supercapacitor means being operable to:
store energy whilst a battery is connected to provide energy to the portable device; and
whilst no battery is connected and operable to provide energy to the portable device:
power the device engine means when the portable device is on; and
power the real-time clock means.

10. A device as claimed in claim 9, wherein the device is arranged so that the supercapacitor means and the battery are able to power the device engine means during high power functions

11. A device as claimed in claim 9, wherein the device is arranged so that the supercapacitor means is operable to reduce a ripple voltage in a supply voltage line, which connects the device engine to the battery.

12. A device as claimed in claim 9, wherein the device is arranged so that the supercapacitor means is operable to provide supplementary current to the device engine means in cold operating conditions.
